(19) United States
(12) Patent Application Publication
(10) Pub. No.: US 2017/0060572 A1
(43) Pub. Date: Mar. 2, 2017

(54) METHOD AND SYSTEM FOR MANAGING REAL-TIME RISKS ASSOCIATED WITH APPLICATION LIFECYCLE MANAGEMENT PLATFORMS

(71) Applicant: Wipro Limited, Bangalore (IN)

(72) Inventor: Jayashree Sripathan, Bangalore (IN)

(21) Appl. No.: 14/884,467

(22) Filed: Oct. 15, 2015

(30) Foreign Application Priority Data
Aug. 28, 2015 (IN) 4538/CHE/2015

(51) Int. Cl. G06F 9/44; G06F 17/30

(52) U.S. Cl. CPC G06F 8/70; G06F 17/30917

(57) ABSTRACT

This technology relates to a method for managing the real-time risks associated with application lifecycle management platforms (ALM) comprising a plurality of application projects. In an embodiment, a risk management computing device is integrated within application lifecycle management platforms. The risk management computing device maps one or more risks from pre-defined risks to one or more delivery parameters. Based on the mapping the risk management computing device monitors one or more delivery parameters for identifying one or more risks associated with the application. On identification of one or more risk, the risk management computing device provides solutions to mitigate the occurrence of one or more risks.

This application claims the benefit of Indian Patent Application Serial No. 4538/CHE/2015 filed Aug. 28, 2015, which is hereby incorporated by reference in its entirety.

### FIELD

This technology is related in general to project management, and more particularly, but not exclusively to a method and system for managing real-time risks associated with Application Lifecycle Management (ALM) platforms.

### BACKGROUND

Generally in the business environment, the key factor for success is efficient management and maintenance of the application projects being developed. Information Technology (IT) organizations maintain the effectiveness of their application projects by implementing and maintaining their projects in a cloud server. The delivery team of the cloud based software maintains the delivery of the application projects specified to them. The application projects being developed are maintained on a platform called as Application Lifecycle Management (ALM). The ALM is a set of pre-defined process and tools that includes definition, design, development, testing, deployment and management of the application projects. Throughout the ALM process, each of these steps are closely monitored and controlled. Application projects present on the application lifecycle management (ALM) platforms needs to be monitored in order to manage the risks associated with it. However managing the risks associated with the application projects is very challenging and needs to be focused.

### SUMMARY

Disclosed herein is the method and system for managing real-time risks associated with application lifecycle management platforms. This is achieved by using a risk management system (also referred to as a risk management computing device, which is integrated or associated with the application lifecycle management (ALM) platforms comprising a plurality of application projects. The risk management system monitors one or more delivery parameters associated with each application project for identifying the occurrence of one or more risks and provide solution to mitigate the occurrence of the one or more risks.

In one embodiment, this technology relates to a method for managing real-time risks associated with application lifecycle management (ALM) platforms comprising a plurality of application projects. The method comprises mapping one or more risks, by a risk management system, from a plurality of pre-defined risks to one or more delivery parameters, wherein the one or more delivery parameters associated with at least one application project are selected from the plurality of application projects. Further, the method monitors the one or more delivery parameters to identify the occurrence of the one or more risks based on the mapping and provides a solution to mitigate occurrences of the one or more risks.

In another embodiment, this technology relates to a risk management system for managing the real-time risks associated with application lifecycle management (ALM) platforms comprising one or more application projects. The risk management system comprises a processor and a memory communicatively coupled to the processor, wherein the memory stores processor executable instructions, which, on execution, causes the processor to map one or more risks, from a plurality of pre-defined risks to one or more delivery parameters, wherein the one or more delivery parameters associated with at least one application project selected from the plurality of application projects. The processor further monitors the one or more delivery parameters to identify the occurrence of the one or more risks based on the mapping and provides a solution to mitigate the occurrence of the one or risks.

In another embodiment, present disclosure relates to a non-transitory computer readable medium including instructions stored thereon that when processed by at least one processor cause a risk management system associated with an application lifecycle management (ALM) to map one or more risks, from a plurality of pre-defined risks, to one or more delivery parameters, wherein the one or more delivery parameters associated with at least one application project are selected from the plurality of application projects. The instructions further cause the risk management system to monitor the one or more delivery parameters to identify the occurrence of the one or more risks based on the mapping. Thereafter, the risk management system provides solution to mitigate the occurrence of the one or more risks.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 shows an exemplary environment for managing real-time risks associated with application lifecycle management (ALM) platforms in accordance with some embodiments of this technology;

FIG. 2 shows a detailed block diagram illustrating a risk management system in accordance with some embodiments of this technology;

FIG. 3 shows an example illustrating risk management database for managing real-time risks associated with an application project in accordance with some embodiments of this technology;

FIG. 4 illustrates a flowchart showing the method for monitoring real-time risks associated with application lifecycle management (ALM) platforms in accordance with some embodiments of present disclosure; and

FIG. 5 illustrates a block diagram of an exemplary computer system for implementing embodiments consistent with this technology.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of this technology. The following description is, therefore, not to be taken in a limiting sense.

This technology relates to a method and system for managing real-time risks associated with application lifecycle management platforms. The method comprises an application lifecycle management platform which is connected to a risk management system. The ALM assigns one or more application projects to the risk management system for managing the risk associated with the application projects. The risk management system manages the risks associated with an application project by mapping the one or more risks from plurality of pre-defined risks, present in the risk database of the risk management system to one or more delivery parameters. The one or more delivery parameters are associated with at least one application project which is selected from the plurality of application projects. Based on the mapping of the one or more risks with delivery parameters, the risk management system monitors the one or more delivery parameters to identify the occurrences of one or more risks. On identification of one or more risks, the risk management system provides solutions to mitigate the occurrence of the identified risks. In such a way, the risk management system provides an automated system for identifying and managing the risks associated with an application project.

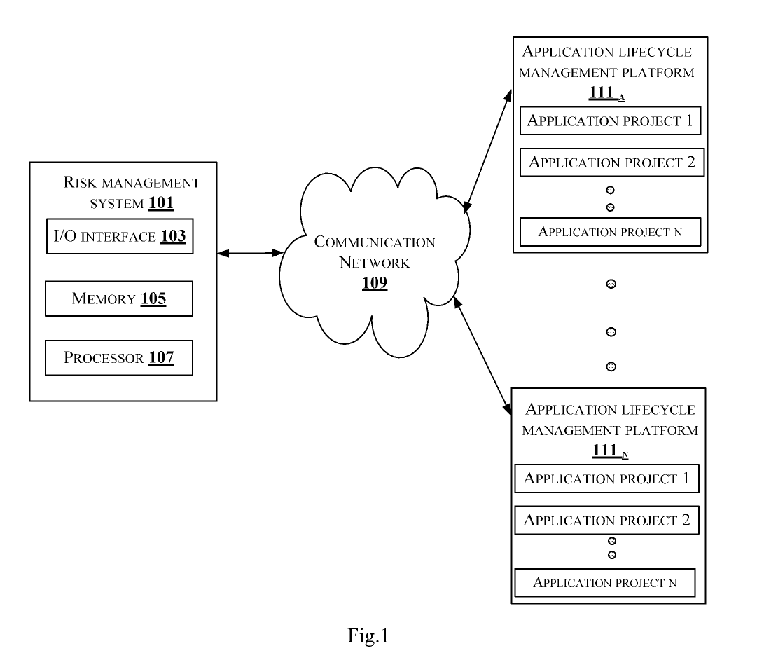

FIG. 1 shows an exemplary environment illustrating a method for monitoring the real-time risks associated with application lifecycle management (ALM) platforms in accordance with some embodiments of this technology.

As shown in FIG. 1, the environment 100 comprises a risk management system 101 connected to Application Lifecycle Management (ALM) platforms 111A . . . 111N (collectively referred as Application Lifecycle Management (ALM) platforms 111) through a communication network 109. In an embodiment, the risk management system 101 is integrated within the application lifecycle management (ALM) platform 111. In another embodiment, the risk management system 101 is connected through at least one of wired or wireless communication network 109 to the ALM platform 111.

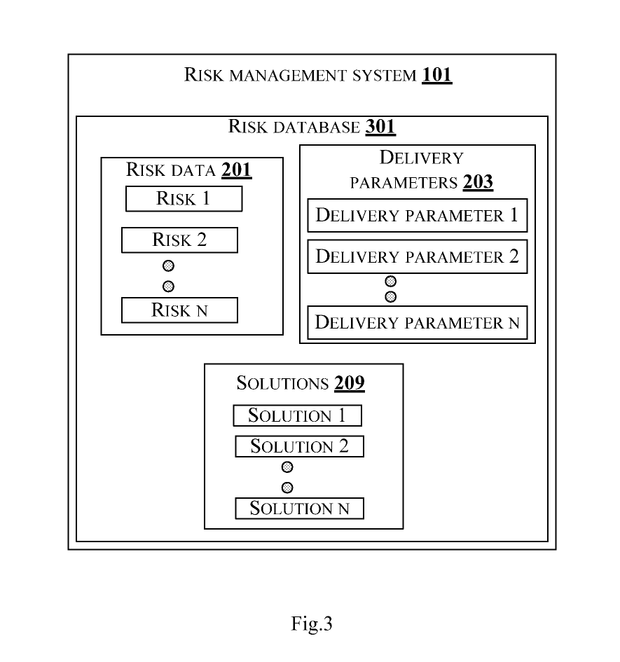

As shown in the FIG. 1, an application lifecycle management platform (ALM) 111 includes plurality of application projects namely application project 1, application project2 to application project n. The risk management system 101 manages risks associated with an application project and also provides automated solutions to overcome the possible risks. The pre-defined risks related to the application project may include, but are not limited to technical risks, organizational risks, business risks and project management risks. A person skilled in the art would understand that any risks related to project are included in scope of this technology. The pre-defined risks can also be categorized further depending on the type of the risks. For example technical risks can be sub-divided into hardware risk, software risks, network risks etc. The user assigns an application project from the ALM 111 to the risk management system 101 from the time of its inception for managing the possible risks. The risk management system 101 on receiving the application project, requests the application lifecycle management platform 111 for the possible delivery parameters associated with the assigned application project. On receiving the delivery parameters, the risk management system 101 maps the one or more risks associated with the assigned application from a plurality of risks present in the risk database (not shown in FIG. 1, covered in FIG. 3) to one or more delivery parameters received. The delivery parameters are monitored by the risk management system 101 for identifying the possible risks associated with the assigned application project. On identifying the occurrence of risks, the risk management system 101 provides solutions to mitigate the occurrence of risks. The solutions for the identified risks are mapped and stored in the risk database.

In one embodiment, if there are some newly identified additional risks with respect to the delivery parameters of the assigned application project, the risk management system 101 updates the additional risks to the risk database and provides solution for the risks by using manual algorithms. The additional risks are the newly identified risks by the risk management system 101 which are not present within the risk database.

In one embodiment, the risk management system 101 also determines the risks other than the pre-defined risks which are present in the risk database but not selected by the user for the application project. The risk management system 101 provides solutions to avoid these risks and also displays the risk mitigation steps for the risks on a display unit (not shown).

The risk management system 101 comprises an I/O interface 103, a memory 105 and a processor 107. The I/O interface 103 is configured to receive the application projects assigned by the application lifecycle management platform 111 for risk management. The I/O Interface 103 also receives the one or more delivery parameters associated with the application project by the application lifecycle management platform 111 for monitoring the risks associated with it. The I/O interface 103 is also configured to receive the one or more pre-defined risks from the risk database (when configured outside the risk management system 101), for mapping the pre-defined risks to one or more delivery parameters associated with the application project.

The received information from the I/O interface 103 is stored in the memory 105. The memory 105 is communicatively coupled to the processor 107. The processor 107 maps the one or more risks to the one or more delivery parameters. The processor 107 monitors the one or more delivery parameters and identifies the occurrence of one or more risks. Based on the identification of risks, the processor 107 provides solution to mitigate the occurrence of one or more risk.

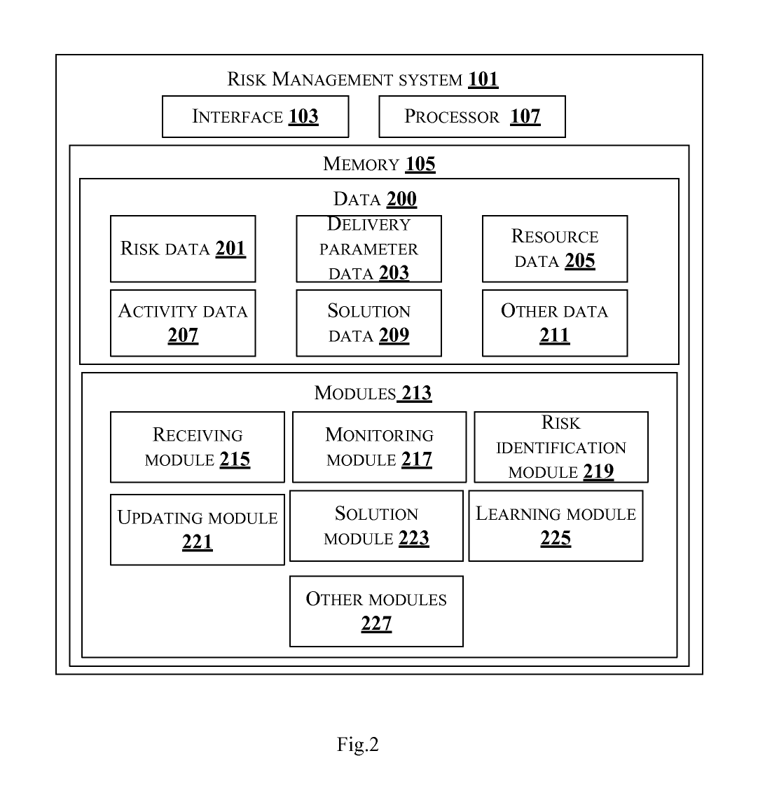

FIG. 2 illustrates a detailed block diagram of the exemplary risk management system 101 with various data and modules for monitoring the real-time risks associated with an application delivery in accordance with some embodiments of this technology.

In the illustrated FIG. 2, the one or more data 200 and the one or more modules 213 stored in the memory 105 are described herein in detail.

In one implementation, the risk management system 101 receives data from the ALM 111 to which the risk management system 101 is connected. In an embodiment, the data 200 includes risk data 201, delivery parameter data 203, resource data 205, activity data 207, solution data 209 and other data 211 for managing the real-time risks in an application project.

The risk data 201 comprises various types of pre-defined risks associated with an application project, present in the risk database. The application lifecycle management platform 111 provides the application project, which is monitored by the risk management system 101. The risks can either be pre-defined or can also be added by the user upon detecting new risk. The pre-defined risks comprise business risks, technical risks, organizational risks and project management risks. The risks can be further categorized based on their type. For example, the business risk can be further divided into competitor risk, cash flow risks, regulatory etc. Similarly organization risks can be subdivided into executive risks, stakeholder risks, approval risk etc.

The delivery parameter data 203 are the data associated with an application project. The delivery parameter data 203 are given as an input to the risk management system 101 for managing one or more risks associated with the application project. As an example, if the application project is required to deliver a service within a specified time period, then the time period is regarded as the delivery parameter for that application project. Further, if the service is not delivered within the specified time, then the delivery parameter becomes a risk for the application project. In one embodiment, the resource data 205 and activity data 207 may also be included in the delivery parameter data 203. For example, the delivery parameters associated with technical risks in terms of hardware risks are the availability of hardware resources, the status of hardware resources like build servers, deployment servers etc.

The resource data 205 comprises various types of resources associated with an application project delivery. The resources are required for executing the application project. The available resources of the application project, for example can be build servers, deployment servers etc. The information related to the resources is provided to the risk management system 101 for monitoring the resources. The application specific resources can be hardware resources, software resources etc. The resources are integrated to the risk database so that the risks associated with the resources of the application project can be monitored. For example, if the hardware resource such as a server associated with an application project faces any problem, it can be monitored by the risk management system 101 in prior and can be resolved immediately by monitoring the resource data 205.

The activity data 207 comprises information associated with the activities performed for executing the application project. The activity data 207 is obtained from the application lifecycle management platform 111. The activity data 207 for each application project in the application lifecycle management 111 is maintained from the inception of the application project. For example, the activities associated with the application project can be gathering requirements, analyzing, deployment, testing etc.

The solution data 207 comprises information associated with one or more solutions for one or more risks associated with an application project. The solution data 207 are mapped with one or more risks in the risk database and stored. For example, consider the risk associated with an application project is a human resource risk, wherein the resource is unable to work on the application project after sometime. In such a case the risk management system 101 provides solutions by associating that application project to another resource in the team with same skill set and informing about the risk to the team. In this way the risk management system 101 provides solutions to overcome the risks.

The other data 209 may store data, including temporary data and temporary files, generated by modules for performing the various functions of the risk management system 101.

In an embodiment, the one or more data 200 in the memory 105 are processed by the one or more modules 213 of the risk management system 101. The one or more modules 213 may be stored within the memory 105 as shown in FIG. 2. In an example, the one or more modules 213, communicatively coupled to the processor 107, may also be present outside the memory 105 and implemented as hardware. As used herein, the term module refers to an application specific integrated circuit (ASIC), an electronic circuit, a processor (shared, dedicated, or group) and memory that execute one or more software or firmware programs, a combinational logic circuit, and/or other suitable components that provide the described functionality.

In one implementation, the one or more modules 213 may include, for example, a receiving module 215, a monitoring module 217, a risk identification module 219, an updating module 221, a learning module 223, and a solution module 225. The memory 105 may also comprise other modules 227 to perform various miscellaneous functionalities of the risk management system 101. It will be appreciated that such aforementioned modules may be represented as a single module or a combination of different modules.

In an embodiment, the receiving module 215 is configured to receive the application project which has to be monitored by the risk management system 101 from the application lifecycle management platform 111. The receiving module 215 is also configured to receive, the one or more delivery parameters associated with the selected application project for mapping the delivery parameters to the one or more pre-defined risks. The information of the one or more pre-defined risks is stored in the risk database of the risk management system 101. As an example, the delivery parameters associated with project management risk include available hours of the resource in project duration compared to assigned work hours in the project tasks. Available hours and assigned hours are the parameters to monitor the risks associated with the application project.

In an embodiment, the monitoring module 217 is configured to monitor one or more delivery parameters associated with the application project. In an embodiment, monitoring the delivery parameters may include monitoring resources and activities of the application project. For example, the hardware resources, used in the application project like the build server or a release management machine etc. The delivery parameters are monitored from the time of the application project inception.

In an embodiment, the risk identification module 219 is configured to identify the possible risks associated with an application project. The risk identification module 219 identifies one or more risks associated with an application project based on the results of the monitoring module 217. In an embodiment, the updating module 221 is configured to update the additional risks which are identified for a particular application project. The identified additional risks are updated to the risk database. The updating module 321 also updates the solutions for the additional risks into the risk database.

In an embodiment, the solution module 223 provides solution with respect to one or more risks identified for an application project. Based on the identified risk, the solution module 223 recommends solutions to overcome the one or more risks. The solution module 223 further provides steps for risk avoidance and risk mitigation. The solutions for one or more risks are mapped with one or more risks and stored in the risk database. The solution module 223 automatically selects a particular solution for one or more risks and mitigates the occurrence of risks.

In an embodiment, the learning module 225 updates all the risk learnings for an application project for future usage of the platform for new releases. The learning module 225 uses a status related to the application project, the corrective actions which are incorporated to manually mitigate the pre-defined risks and also the solutions developed for one or more additional risks.

FIG. 3 shows an example illustrating risk management database for managing real-time risks associated with an application project in accordance with some embodiments of this technology;

The risk management system 101 as shown in FIG. 3 comprises of a risk database 301. The risk database 301 contains all the types of the pre-defined risks associated with the one or more application project. Further the risk database 301 comprises information of one or more delivery parameters received from the application lifecycle management platform 111. The delivery parameters are mapped with the one or more pre-defined risks present in the risk database 301. The risk database 301 also contains the solutions mapped with each type of pre-defined risks to mitigate the occurrence of these risks. As an example, a user may select an application project 1 from the plurality of application projects in the application lifecycle management platform 111 for monitoring the risks associated with the application project 1. The user can also select certain pre-defined risks to be monitored for the application project. The risk management system 101 requests the application lifecycle management (ALM) platform 111 for the delivery parameters associated with the application project 1. As an example, the delivery parameters associated with application project1 are available hours of the resources in the project duration to assigned hours, skills of the resources identified during deliverables, scheduled adherence of the resource etc. On receiving the delivery parameters, the risk management system 101 maps one or more pre-defined risks from the risk database 301 to the received delivery parameters. As an example, if the delivery parameter is the available hours of the resource in the application project 1 with respective to assigned hours, than the risks associated with it can be incompletion of the application project within specified duration. In such a case, the risk is mapped with the delivery parameter.

Based on the mapping, the risk management system 101 monitors the delivery parameters to identify the risk. On identifying the risk, the risk management system 101 solves the risk by providing a solution for the incompletion risk which was already mapped and stored in the risk database 301. In this case, the solution is to calculate the remaining time available with the resource for carrying out the application project 1. The solution is automated by the risk management system 101 to the application lifecycle management platform 111.

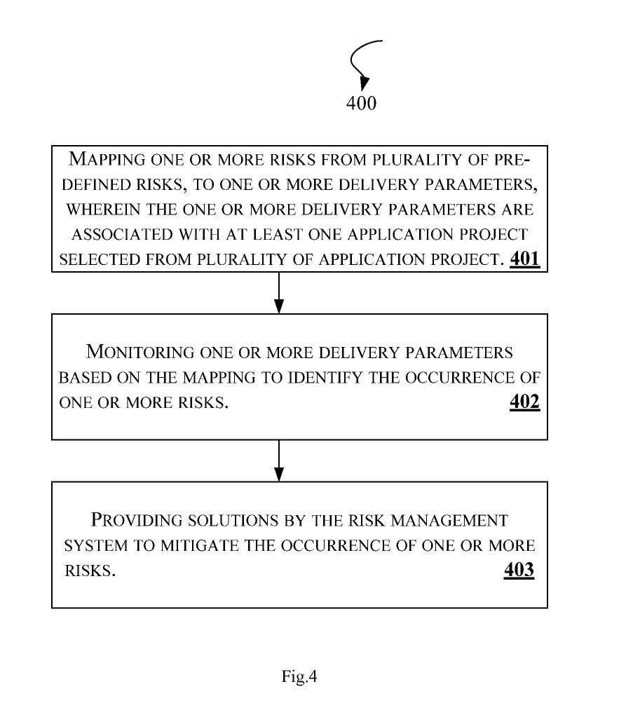

FIG. 4 illustrates a flowchart showing the method for monitoring the real-time risks associated with an application lifecycle management (ALM) platform in accordance with some embodiments of present disclosure.

As illustrated in FIG. 4, the method 400 comprises one or more blocks for managing the real-time risks associated with an application lifecycle management platform 111. The method 400 may be described in the general context of computer executable instructions. Generally, computer executable instructions can include routines, programs, objects, components, data structures, procedures, modules, and functions, which perform particular functions or implement particular abstract data types.

The order in which the method 400 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof

An application project present in the application lifecycle management platforms 111 requires the management of real-time risks associated with it. For the management of the real-time risks the ALM 111 is connected with a risk management system 101.

The person concerned or team members associated with the application project to be monitored, can select the one or more risks from a plurality of predefined risks associated with the application project.

The ALM platform 111 provides delivery parameters with respect to the application project which are monitored from the time of inception of the application project.

At block 401, one or more risks, from the plurality of pre-defined risks are mapped to one or more delivery parameters. The one or more delivery parameters are associated with at least one application project which is selected from the plurality of application projects.

At block 403, one or more delivery parameters are monitored to identify the occurrence of one or more risks based on the mapping. In an embodiment, the delivery parameters to be monitored include one or more resources and activities which are associated with the application project.

At block 405, a solution is provided by the risk management system 101 to mitigate the occurrence of the one or more risks. Hence managing the risks associated with the application lifecycle management platform 111.

In one embodiment, the solutions can either be provided by the risk management system 101 or it can be mitigated manually using knowledge of team members.

In one embodiment, the risk management system 101 determines risks other than the one or more pre-defined risks selected by the concerned person associated with the application project. Also, the risk management system 101 provides solutions for providing risk avoidance and risk mitigation to stop the occurrence of risks.

In one embodiment, the risk management system 101 identifies additional risks associated with the application project, wherein the additional risks are not present in the risk database 301.

The risk management system 101 further updates the additional risks to the risk database 301 and also provides a solution for them.

In one embodiment, the solutions provided manually by the team members are updated to the risk database 301 of the risk management system 101.

### Computer System

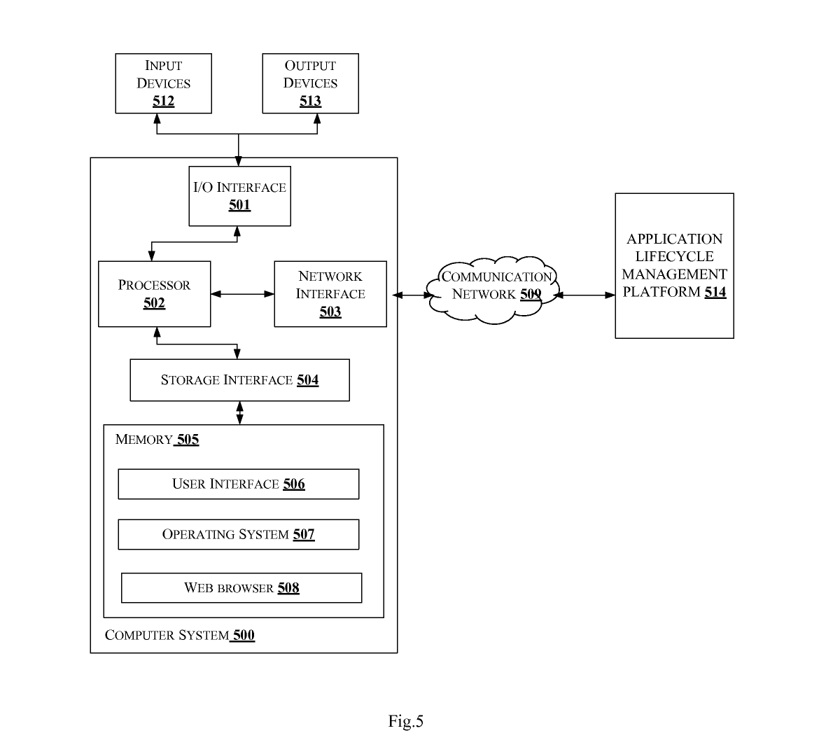

FIG. 5 illustrates a block diagram of an exemplary computer system 500 for implementing embodiments consistent with this technology. In an embodiment, the computer system 500 is used to implement the risk management system 101. The computer system 500 may comprise a central processing unit (“CPU” or “processor”) 502. The processor 502 may comprise at least one data processor for managing the one or more real-time risks associated with an application lifecycle management platform. The processor 502 may include specialized processing units such as integrated system (bus) controllers, memory management control units, floating point units, graphics processing units, digital signal processing units, etc.

The processor 502 may be disposed in communication with one or more input/output (I/O) devices (not shown) via I/O interface 501. The I/O interface 501 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 501, the computer system 500 may communicate with one or more I/O devices. For example, the input device may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system 500 is connected to an application lifecycle management platform 514. The processor 502 may be disposed in communication with the communication network 509 via a network interface 503. The network interface 503 may communicate with the communication network 509. The network interface 503 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 509 may include, without limitation, a direct interconnection, local area network (LAN), wide area network (WAN), wireless network (e.g., using Wireless Application Protocol), the Internet, etc. Using the network interface 503 and the communication network 509, the computer system 500 may communicate with the application lifecycle management platform 514. The network interface 503 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 509 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 502 may be disposed in communication with a memory 505 (e.g., RAM, ROM, etc. not shown in FIG. 5) via a storage interface 504. The storage interface 504 may connect to memory 505 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user interface 506, an operating system 507, web server 508 etc. In some embodiments, computer system 500 may store user/application data 506, such as the data, variables, records, etc. as described in this disclosure. Such databases may be implemented as fault-tolerant, relational, scalable, secure databases such as Oracle or Sybase.

The operating system 507 may facilitate resource management and operation of the computer system 500. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like.

In some embodiments, the computer system 500 may implement a web browser 508 stored program component. The web browser 508 may be a hypertext viewing application, such as Microsoft Internet Explorer, Google Chrome, Mozilla Firefox, Apple Safari, etc. Secure web browsing may be provided using Secure Hypertext Transport Protocol (HTTPS), Secure Sockets Layer (SSL), Transport Layer Security (TLS), etc. Web browsers 508 may utilize facilities such as AJAX, DHTML, Adobe Flash, JavaScript, Java, Application Programming Interfaces (APIs), etc. In some embodiments, the computer system 500 may implement a mail server stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 500 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with this technology. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD ROMs, DVDs, flash drives, disks, and any other known physical storage media.

Advantages of the embodiment of this technology are illustrated herein. An embodiment of this technology manages real-time risks associated with an application project present in the ALM. Embodiments of this technology provide an automated system for managing real-time risks in an application lifecycle management platform. Embodiments of this technology provides an automated system for risk management, this reduces the error prone to updating the risks manually by the team members of the application project.

This technology also helps in reducing the time spent by the delivery team members in managing the real-time risks associated with an application project. This technology, in addition to the pre-defined risks, also identifies the unknown risks, i.e. risks which were not defined in the risk database.

In one embodiment, the risk management system considers all the factors which are responsible for causing a risk during the application project lifecycle. This helps in providing an accurate method of identifying the risks.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media comprise all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the invention, and that the article of manufacture may comprise suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 4 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for providing a solution to mitigate one or more risks, the method comprising:
mapping, by a risk management system, the one or more risks, from a plurality of predefined risks, to one or more delivery parameters, wherein the one or more delivery parameters are associated with at least one application project selected from a plurality of application projects;
monitoring, by the risk management system, the one or more delivery parameters to identify occurrence of the one or more risks based on the mapping, wherein at least one of the one or more risks corresponds to a human resource risk;
obtaining, by the risk management system, a risk-solution mapping from a risk database, wherein the risk-solution mapping comprises a plurality of risk mitigation solutions mapped to the one or more risks from the plurality of predefined risks; and
providing, by the risk management system, at least one risk mitigation solution, from the plurality of risk mitigation solutions, based on the obtained risk-solution mapping, wherein the at least one risk mitigation solution corresponds to associating another human resource with a same skill set to the at least one application project.

2. The method as claimed in claim 1, wherein the plurality of predefined risks are obtained from the risk database comprising at least one of business risks, technical risks, organizational risks and project management risks.

3. The method as claimed in claim 1, wherein the one or more delivery parameters are monitored at predefined intervals of time from inception of the at least one application project from the plurality of application projects.

4. (canceled)

5. The method as claimed in claimed in claim 1 further comprising:
determining, by the risk management system, risks other than the one or more risks corresponding to the at least one application project; and
providing, by the risk management system, solutions for at least one of risk avoidance and risk mitigation to stop occurrence of the risks.

6. The method as claimed in claim 1 further comprising:
identifying, by the risk management system, additional risks associated with the at least one application project, wherein the additional risks are not present in the risk database; and
updating the additional risks to the plurality of predefined risks present in the risk database.

7. A risk management system for providing a solution to mitigate one or more risks, the risk management system comprising:
a processor; and
a memory communicatively coupled to the processor, wherein the memory stores processor instructions, which, on execution, causes the processor to:
map the one or more risks, from a plurality of predefined risks, to one or more delivery parameters, wherein the one or more delivery parameters are associated with at least one application project selected from a plurality of application projects;
monitor the one or more delivery parameters to identify occurrence of the one or more risks based on the mapping, wherein at least one of the one or more risks corresponds to a human resource risk;
obtain a risk-solution mapping from a risk database, wherein the risk-solution mapping comprises a plurality of risk mitigation solutions mapped to the one or more risks from the plurality of predefined risks; and
provide at least one risk mitigation solution, from the plurality of risk mitigation solutions, based on the obtained risk-solution mapping, wherein the at least one risk mitigation solution corresponds to associating another human resource with a same skill set to the at least one application project.

8. The risk management system as claimed in claim 7, wherein the processor obtains the plurality of predefined risks from the risk database comprising at least one of business risks, technical risks, organizational risks and project management risks.

9. The risk management system as claimed in claim 7, wherein the processor monitors the one or more delivery parameters at predefined intervals of time from inception of the at least one application project from the plurality of application projects.

10. (canceled)

11. The risk management system as claimed in claim 7, wherein the processor further performs:
determining risks other than the one or more risks corresponding to the at least one application project; and
providing solutions for at least one of risk avoidance and risk mitigation to stop occurrence of the risks.

12. The risk management system as claimed in claim 7, wherein the processor further performs:
identifying additional risks associated with the at least one application project, wherein the additional risks are not present in the risk database; and
updating the additional risks to the plurality of predefined risks present in the risk database.

13. A non-transitory computer readable medium including instruction stored thereon that when processed by at least one processor cause a risk management system to perform operation comprising:
mapping one or more risks, from a plurality of predefined risks, to one or more delivery parameters, wherein the one or more delivery parameters are associated with at least one application project selected from a plurality of application projects;
monitoring the one or more delivery parameters to identify occurrence of the one or more risks based on the mapping, wherein at least one of the one or more risks corresponds to a human resource risk;
obtaining a risk-solution mapping from a risk database, wherein the risk-solution mapping comprises a plurality of risk mitigation solutions mapped to the one or more risks from the plurality of predefined risks; and
providing at least one risk mitigation solution, from the plurality of risk mitigation solutions, based on the obtained risk-solution mapping, wherein the at least one risk mitigation solution corresponds to associating another human resource with a same skill set to the at least one application project.

14. The medium as claimed in claim 13, wherein the instruction causes the processor to obtain the plurality of predefined risks from the risk database comprising at least one of business risks, technical risks, organizational risks and project management risks.

15. The medium as claimed in claim 13, wherein the instruction causes the processor to monitor one or more delivery parameters at predefined intervals of time from inception of the at least one application project from the plurality of application projects.

16. (canceled)

17. The medium as claimed in claim 13, wherein the instruction causes the processor to:
determine risks other than the one or more risks corresponding to the at least one application project; and
provide solutions for at least one of risk avoidance and risk mitigation to stop occurrence of the risks.

18. The medium as claimed in claim 13, wherein the instruction causes the processor to further:
identify additional risks associated with the at least one application project, wherein the additional risks are not present in the risk database; and
update the additional risks to the plurality of predefined risks present in the risk database.
